(19) United States
(12) Patent Application Publication
(10) Pub. No.: US 2014/0116185 A1
(43) Pub. Date: May 1, 2014

(54) STEERING COLUMN ASSEMBLY WITH IMPROVED ATTACHMENT TO A VEHICLE STRUCTURE

(71) Applicant: Melvin L. Tinnin, Clio, MI (US)

(72) Inventor: Melvin L. Tinnin, Clio, MI (US)

(21) Appl. No.: 13/664,882

(22) Filed: Oct. 31, 2012

(51) Int. Cl. B62D 1/184

(52) U.S. Cl. 74/493

(57) ABSTRACT

A steering column assembly comprises an upper column jacket defining an internal cavity, a clamping shaft, a retainer disposed at an outboard end of the clamping shaft, and an inner clamping block disposed in the internal cavity. A steering control shaft is supported for rotation about a longitudinal column axis through the internal cavity. The clamping shaft defines a clamping axis and has an in-board end that is configured to interact with the inner clamping block. The inner clamping block is configured for interacting with the clamping shaft to impose a compressive load on the upper column jacket between the retainer and the inner clamping block.

### BACKGROUND OF THE INVENTION

The present invention relates to steering columns and more particularly to systems and methods for attaching and releasing a steering column assembly to a structure of a vehicle.

Market forces are inducing vehicle suppliers to seek ways of meeting the sometimes conflicting desires to incorporate new features into the areas surrounding the vehicle steering column while also providing more compact vehicles. As a result, demands for space surrounding the steering column have increased while the space available has decreased. In particular, it is becoming more and more common for the space above and below the column to be limited. These space-based constraints have posed challenges to designers seeking to meet requirements relating to structural attachment of the steering column to the vehicle, to safety and reliability, and also to convenience. In particular, consumer desires for the ability to adjust positioning of the steering column have not decreased to accommodate the above-described increasing demands for space.

Accordingly, it is desirable to have improved systems and methods for selectively fixing and releasing a steering column while also providing for safe and reliable structural attachment of the steering column within reduced spaces above and beneath the steering column. It is also desirable to have a system and method for selectively fixing and releasing a steering column wherein the clamping hardware is disposed primarily toward a side of the steering column (e.g., arranged substantially horizontally from a centerline of the steering column)

### SUMMARY OF THE INVENTION

In one exemplary embodiment of the invention, a steering column assembly comprises an upper column jacket defining an internal cavity, a clamping shaft, a retainer disposed at an outboard end of the clamping shaft, and an inner clamping block disposed in the internal cavity. A steering control shaft is supported for rotation about a longitudinal column axis through the internal cavity. The clamping shaft defines a clamping axis and has an in-board end that is configured to interact with the inner clamping block. The inner clamping block is configured for interacting with the clamping shaft to impose a compressive load on the upper column jacket between the retainer and the inner clamping block.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows a perspective view of an exemplary steering column assembly;

FIG. 2 shows a side view of an exemplary steering column assembly;

FIG. 3 shows a perspective view of a portion of a steering column assembly, with segments of the steering column assembly cut away to show otherwise hidden aspects steering column assembly; and

FIG. 4 shows a perspective view of a portion of an exemplary steering column assembly.

### DETAILED DESCRIPTION

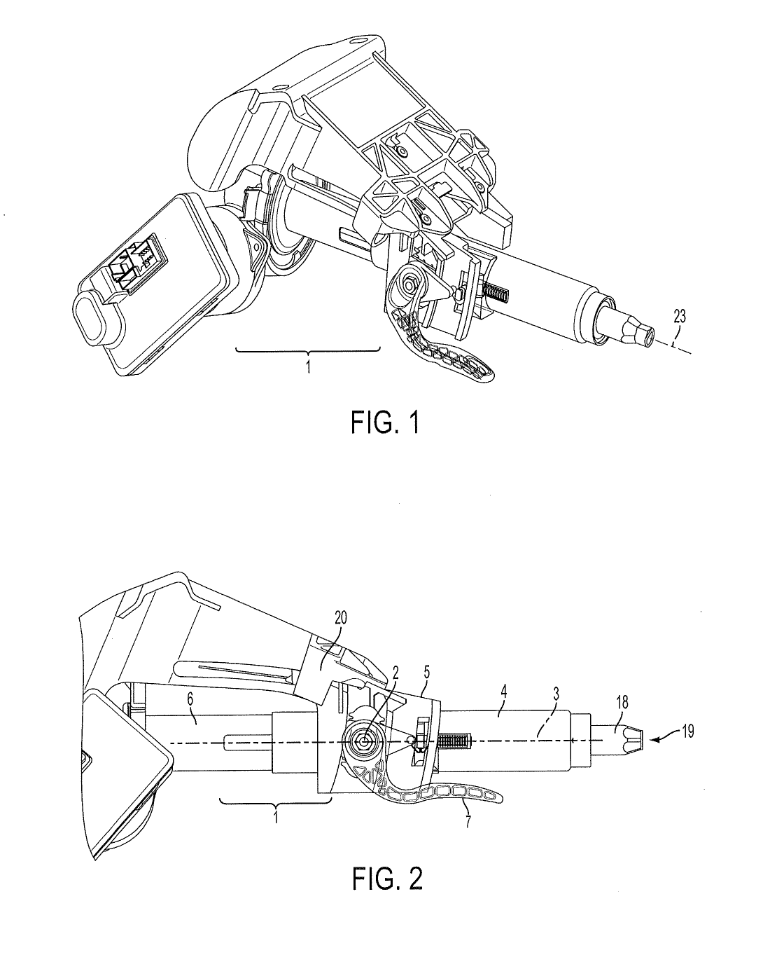

Referring now to the Figures, where the invention will be described with reference to specific embodiments, without limiting same, FIG. 1 and FIG. 2 show respective perspective and side views of a steering column assembly 1 in accordance with the invention. As shown in FIG. 1 and FIG. 2, the steering column assembly 1 comprises an upper column jacket 4, through which a steering control shaft 18 is supported for rotation about a longitudinal column axis 3. At an operator end (i.e., an upper end) 19, the steering control shaft 18 is configured for interacting with a steering wheel or other user control device (not shown) for facilitating user control of the vehicle. At an opposite end (i.e., a lower end) the steering control shaft 18 is coupled (e.g., via an intermediate shaft and/or via one or more gear mechanisms) to a steerable wheel of the vehicle. Thus, as an operator rotates a steering wheel of the vehicle, the steering control shaft 18 rotates about the longitudinal column axis 3, and control of the vehicle is provided.

In an exemplary embodiment, the steering column assembly 1 is arranged in a plane that is oriented vertically and that includes a longitudinal axis 23 of the vehicle. Adjustments to the position and orientation of the steering column assembly 1 may be facilitated in either or both of: (1) along the of the longitudinal column axis 3 (i.e., in a telescoping direction); and (2) in a vertical (i.e., raking) direction substantially perpendicular to the longitudinal column axis 3. To facilitate such adjustments to the position and orientation of the steering column assembly 1, the steering column assembly 1 includes a position lock bracket 5 that is disposed about the generally cylindrical upper column jacket 4 and configured for cooperating with mating lock plates 13. The position lock bracket 5, in cooperation with the lock plates 13, facilitates selectively enabling (i.e., in an adjustment mode) adjustments to the position of the operator end 19 of the steering control shaft 18 within a range of adjustment defined by a slot in the position lock bracket 5. In an exemplary embodiment, the position lock bracket 5 defines a lock bracket slot through which the clamping shaft 2 is disposed. To facilitate structural attachment to the vehicle (i.e., in a locked mode), the position lock bracket 5 is fixed to a column mounting bracket 20, which is fixed to the vehicle.

To enable the locked mode, wherein changes to the position of the operator end 19 of the steering control shaft 18 are substantially inhibited, the position lock mechanism 21 is configured to substantially fix the position of the upper column jacket 4 relative to the position lock bracket 5 (and, therefore, relative to the column mounting bracket 20 and the vehicle) when the position lock mechanism 21 occupies the locked mode. Similarly, to enable the adjustment mode, wherein changes to the position of the operator end 19 of the steering control shaft 18 are facilitated, the position lock mechanism 21 is configured to permit adjustments to the position of the upper column jacket 4 relative to the position lock bracket 5 (and, therefore, relative to the column mounting bracket 20 and the vehicle) when the position lock mechanism 21 occupies the adjustment mode.

Those skilled in the art will appreciate that a number of methods are known for enabling the above-described locking and adjustment modes. For example, the locked mode may be activated by imposing a compressive load between adjacent friction lock members or by engaging sets of mating gears so as to inhibit relative movement. Similarly, the adjustment mode may be activated by releasing the compressive loads or disengaging the gear teeth. To provide operator selectivity between the locked mode and the adjustment mode, an adjustment lever arm 7 may be provided for releasing or applying the compressive load (or for engaging and disengaging the gear teeth) based on the position of the adjustment lever arm 7.

In an exemplary embodiment, as shown in FIG. 1 and FIG. 2, a position lock mechanism 21 includes a rake lock actuator (not shown) and/or a telescope lock actuator (not shown). An adjustment lever arm 7 is coupled to the rake lock actuator and/or the telescope lock actuator such that the vehicle operator may select (e.g., by manipulating the adjustment lever arm 7) whether the position lock mechanism 21 is to occupy the locked mode or the adjustment mode. In embodiments that provide for telescoping adjustments of the steering column assembly 1, the position lock bracket 5 and the position lock mechanism 21 are configured to cooperate so as to selectively enable such telescoping adjustments while in the adjustment mode and to prevent such telescoping adjustments while in the locked mode. Similarly, in embodiments that provide for raking adjustments of the steering column assembly 1, the position lock bracket 5 and the position lock mechanism 21 are configured to selectively enable such raking adjustments while in the adjustment mode and to prevent such raking adjustments while in the locked mode.

During normal operation of the vehicle, the position lock bracket 5 and the position lock mechanism 21 occupy the locked mode such that the upper column jacket 4 is fixed relative to the position lock bracket 5. To enhance vehicle safety in situations wherein the vehicle encounters an excessive acceleration (e.g., such that a vehicle occupant may impact or press against the steering column assembly 1), the position lock bracket 5 and the position lock mechanism 21 may be configured to release from the vehicle upon imposition of an impact force of sufficient magnitude. Alternatively, it may be the position lock mechanism 21 that is configured to selectively release the upper column jacket 4 from its fixed relationship to the position lock bracket 5. In either of these configurations, however, the fixed relationship between the steering column assembly 1 and the vehicle is to be released upon the occurrence of the predetermined criteria. Thus, it is important for the attachment system and method to provide a reliable structural attachment between the steering column and the vehicle.

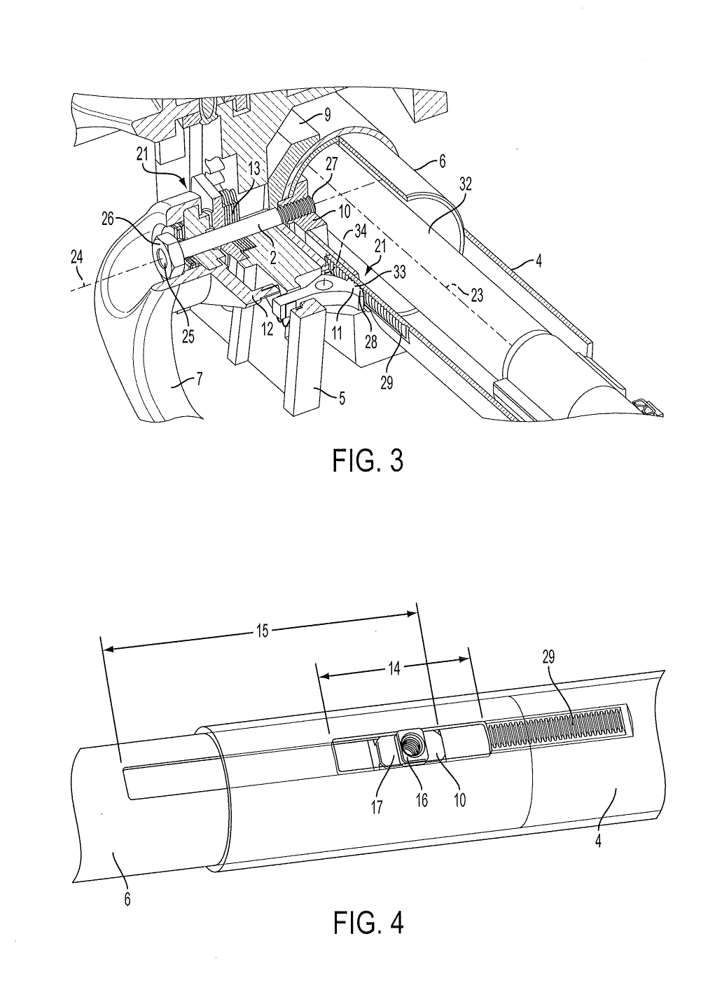

FIG. 3 shows a perspective view of an exemplary steering column assembly 1 with portions of the upper column jacket 4 and the position lock bracket 5 cut away to better illustrate the position lock mechanism 21 and its cooperation with the position lock bracket 5 and the upper column jacket 4 to provide the functional attributes described above. As shown in FIG. 3, in an exemplary embodiment, a position lock mechanism 21 includes an adjustment lever arm 7 and one or more lock plates 13 positioned adjacent to the position lock bracket 5. The adjustment lever arm 7, the one or more lock plates 13, and the position lock bracket 5 each define a bore through which a clamping shaft 2 is disposed. In addition to passing through bores defined in these components, the clamping shaft 2 is structurally coupled to the upper column jacket 4 as discussed more fully below.

In an exemplary embodiment, the upper column jacket 4 defines an internal cavity 32, within which the steering control shaft 18 is supported. In an exemplary embodiment, an inner column jacket 6 is disposed within the internal cavity 32. The inner column jacket 6 may be in direct contact with the upper column jacket 4 or they may be separated by a bushing or bearing assembly to facilitate reliable telescoping movement relative to one another while also providing structural coupling the between inner column jacket 6 and the upper column jacket 4. Thus, the inner column jacket 6 and the upper column jacket 4 are configured for telescoping movement along the longitudinal column axis 3.

In addition to passing through the adjustment lever arm 7, the one or more lock plates 13, and the position lock bracket 5, the clamping shaft 2 also passes through an upper jacket slot 14 defined in the upper column jacket 4 and an inner jacket slot 15 defined in the inner column jacket 6. A retainer 26 is disposed at an outboard end 25 of the clamping shaft 2 and may comprise a head fixed to the clamping shaft 2 or, alternatively, a threaded lock nut whose position on the clamping shaft 2 may be adjusted as it is threaded onto mating threads of the clamping shaft 2. At an in-board end 27 of the clamping shaft 2, an inner clamping block 10 cooperates with the clamping shaft 2 such that a compressive force may be exerted between the one or more lock plates 13 and the position lock bracket 5 as the clamping shaft 2 is placed in tension between the retainer 26 and the inner clamping block 10. In an exemplary embodiment, the in-board end 27 of the clamping shaft 2 is threaded, i.e., the clamping shaft 2 has a threaded end. As a result of the imposition of these forces, the one or more lock plates 13 may resist relative movement of the clamping shaft 2 relative to the position lock bracket 5. At the same time, the inner clamping block 10, which is disposed within the internal cavity 32, fixes the position of the clamping shaft 2 relative to the upper column jacket 4.

Accordingly, the lock plates 13, in cooperation with the position lock bracket 5 and the upper column jacket 4, provides a mechanism for selectively enabling or preventing adjustments to the position of the operator end 19 of the steering control shaft 18 in at least the direction associated with interaction of the one or more lock plates 13 and the position lock bracket 5. It should be noted, however, that the one or more lock plates 13 and the position lock bracket 5 may be configured to provide adjustment of the position of the steering column assembly 1 along one axis or two axes. More specifically, the one or more lock plates 13 and the position lock bracket 5 may be configured to provide adjustment/locking along only the raking direction, along only the telescoping direction, or along both telescoping and raking directions.

Where the one or more lock plates 13 and the position lock bracket 5 are configured to facilitate adjustment/locking along only a single direction, adjustments/locking in a second direction may be provided by additional locking/adjustment features that may also be actuated by the adjustment lever arm 7. In an exemplary embodiment, where the one or more lock plates 13 and the position lock bracket 5 provide for adjustments in the raking direction, a position lock mechanism 21 further comprises an eccentric cam 11 disposed on the position lock bracket 5 for pivoting movement about a pivot axis 34. The eccentric cam 11 includes a plurality of locking cam teeth 28 disposed along a cam surface 33.

In an exemplary embodiment, an appendage 12 that is coupled to, and actuated by, the adjustment lever arm 7 interacts with the eccentric cam 11 when the adjustment lever arm 7 is manipulated so as to move the locking cam teeth 28 into and out of engagement with complementary locking column teeth 29 disposed on the upper column jacket 4. When the plurality of locking cam teeth 28 of the eccentric cam 11 are in locking engagement with the complementary locking column teeth 29 of the upper column jacket 4, telescoping movement of the upper column jacket 4 relative to the position lock bracket 5 is prevented. When the plurality of locking cam teeth 28 of the eccentric cam 11 are in disengaged from the complementary locking column teeth 29 of the upper column jacket 4, telescoping movement of the upper column jacket 4 relative to the position lock bracket 5 is enabled.

In an exemplary embodiment, the position lock mechanism 21 is disposed along a side of the upper column jacket 4 that is disposed along a substantially horizontal direction from the longitudinal column axis 3. The clamping shaft 2 defines a clamping axis 24 along its length, and, in an exemplary embodiment, the clamping axis 24 is disposed generally horizontally and passes through, or nearly through, the longitudinal column axis 3. In an exemplary embodiment, the clamping shaft 2 is arranged so that the clamping axis 24 is directed substantially toward the longitudinal column axis 3. As discussed above, the in-board end 27 of the clamping shaft 2 passes through the upper jacket slot 14 defined in the upper column jacket 4 and the inner jacket slot 15 defined in the inner column jacket 6 and interacts with the inner clamping block 10, which is disposed within the internal cavity 32. In an exemplary embodiment, the in-board end 27 of the clamping shaft 2 is threaded and is disposed within an internal, threaded bore that is defined in the inner clamping block 10, such that, as the clamping shaft 2 rotates about the clamping axis 24 in a clamping direction, it draws the inner clamping block 10 against the upper column jacket 4 and thereby imposes a compressive load on the upper column jacket 4. Similarly, as the clamping shaft 2 rotates about the clamping axis 24 in a releasing direction, it releases the inner clamping block 10 away from the upper column jacket 4 and thereby frees the upper column jacket 4.

In an exemplary embodiment, an outer clamping block 9 is disposed between the upper column jacket 4 and the position lock bracket 5 such that the clamping shaft 2 also passes through a bore in the outer clamping block 9. Both the inner clamping block 10 and the outer clamping block 9 are shaped so as to be complementary in shape to the adjacent surfaces of the upper column jacket 4 and the inner column jacket 6. Thus, as the inner clamping block 10 is drawn against the upper column jacket 4 (i.e., against the inner column jacket 6), a compressive force is applied to the upper column jacket 4 and the inner column jacket 6 between the inner clamping block 10, the outer clamping block 9, and the position lock bracket 5.

In an exemplary embodiment, the clamping shaft 2 is oriented substantially perpendicular to the upper column jacket 4 at the location where the clamping shaft 2 passes through the upper column jacket 4. Accordingly, compressive forces imposed on the upper column jacket 4 between the inner clamping block 10 and the outer clamping block 9 are substantially normal to the surfaces of the upper column jacket 4. The areas across which the inner clamping block 10 and the outer clamping block 9 impose these compressive loads are defined by the areas of the inner clamping block 10 and the outer clamping block 9, and these areas can be designed so as to provide advantageous stress distributions across the surfaces of the upper column jacket 4.

FIG. 4 shows a perspective view of a portion of an upper column jacket 4 in cooperation with an inner column jacket 6 and an exemplary inner clamping block 10. As shown in FIG. 4, an exemplary upper column jacket 4 defines the upper jacket slot 14 along a side of the upper column jacket 4 parallel to the longitudinal column axis 3. The inner column jacket 6 defines a complementary inner jacket slot 15 along a side of the inner column jacket 6, also parallel to the longitudinal column axis 3. A first projected volume 16 of the inner clamping block 10 is disposed in the inner jacket slot 15 and the upper jacket slot 14 so as constrain the movement of the upper column jacket 4 and the inner column jacket 6 relative to the inner clamping block 10. A second projected volume 17 of the inner clamping block 10 is disposed in the inner jacket slot 15 so as constrain the movement of the inner column jacket 6 relative to the inner clamping block 10. Accordingly, when the upper column jacket 4 and the inner column jacket 6 are not compressed between the inner clamping block 10 and the outer clamping block 9, the upper column jacket 4 may undergo telescoping movement relative to the inner column jacket 6 until the second projected volume 17 of the inner clamping block 10 has traversed the entire length of the inner jacket slot 15 and the first projected volume 16 of the inner clamping block 10 has traversed the entire length of the upper jacket slot 14.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. A steering column assembly comprising:
an upper column jacket defining an internal cavity, through which a steering control shaft is supported for rotation about a longitudinal column axis;
a clamping shaft that defines a clamping axis, the clamping shaft having an in-board end that is configured to interact with an inner clamping block disposed in the internal cavity; and
a retainer disposed at an outboard end of the clamping shaft;
the inner clamping block being configured for interacting with the clamping shaft to impose a compressive load on the upper column jacket between the retainer and the inner clamping block.

2. A steering column assembly as described in claim 1, wherein the clamping shaft has a threaded end that is disposed within a threaded bore defined in the inner clamping block such that, as the clamping shaft is rotates about the clamping axis in a clamping direction, the inner clamping block imposes a compressive load on the upper column jacket.

3. A steering column assembly as described in claim 1, wherein the upper column jacket defines an upper jacket slot along a side of the upper column jacket, and wherein the upper jacket slot is oriented parallel to the longitudinal column axis

4. A steering column assembly as described in claim 3, wherein the inner clamping block defines a first projected volume that is disposed in the upper jacket slot so as constrain movement of the upper column jacket relative to the inner clamping block.

5. A steering column assembly as described in claim 1, further comprising an inner column jacket disposed within the upper column jacket.

6. A steering column assembly as described in claim 5, wherein the inner clamping block is configured and positioned to impose a compressive load on the inner column jacket between the retainer and the inner clamping block.

7. A steering column assembly as described in claim 6, wherein the inner column jacket defines an inner jacket slot along a side of the inner column jacket, the inner jacket slot being oriented parallel to the longitudinal column axis.

8. A steering column assembly as described in claim 7, wherein the inner clamping block defines a second projected volume that is disposed in the inner jacket slot so as constrain movement of the inner column jacket relative to the inner clamping block.

9. A steering column assembly as described in claim 8, wherein the upper column jacket defines an upper jacket slot along a side of the upper column jacket, the upper jacket slot being oriented parallel to the longitudinal column axis.

10. A steering column assembly as described in claim 9, wherein the inner clamping block defines a first projected volume that is disposed in the upper jacket slot so as constrain the movement of the upper column jacket relative to the inner clamping block.

11. A steering column assembly as described in claim 1, further comprising a position lock bracket that is disposed about the upper column jacket and that is configured to be fixed to a vehicle, the position lock bracket defining a lock bracket slot; wherein the clamping shaft is disposed through the lock bracket slot, and wherein the inner clamping block and the clamping shaft are configured for interacting to impose a compressive load between the upper column jacket and the position lock bracket

12. A steering column assembly as described in claim 11, further comprising an outer clamping block disposed between the upper column jacket and the position lock bracket such that the clamping shaft also passes through a bore in the outer clamping block.

13. A steering column assembly as described in claim 1, wherein the inner clamping block is shaped so as to be complementary in shape to the upper column jacket.

14. A steering column assembly as described in claim 12, wherein the outer clamping block is shaped so as to be complementary in shape to the upper column jacket.

15. A steering column assembly as described in claim 1, wherein the clamping shaft is disposed so that the clamping axis is substantially horizontal.

16. A steering column assembly as described in claim 1, wherein the clamping shaft is disposed so that the clamping axis substantially perpendicular to the upper column jacket where the inner clamping block imposes the compressive load on the upper column jacket.

17. A steering column assembly as described in claim 1, wherein the clamping shaft is disposed so that the clamping axis is directed substantially toward the longitudinal column axis.

18. A steering column assembly as described in claim 11;
further comprising one or more lock plates disposed adjacent to the position lock bracket;
wherein the clamping shaft passes through the one or more lock plates such that the clamping shaft and the one or more lock plates are constrained from translation relative to one another transversely to the clamping axis;
and wherein the inner clamping block and the clamping shaft are configured for interacting to impose a compressive load between the one or more lock plates and the position lock bracket, and to thereby resist relative movement between the one or more lock plates and the position lock bracket, when the clamping shaft is placed in a locked mode.

19. A steering column assembly as described in claim 18, further comprising an adjustment lever arm coupled to the clamping shaft for moving the clamping shaft from a locked mode to an adjustment mode.

20. A steering column assembly as described in claim 5, wherein the inner column jacket and the upper column jacket are configured for telescoping movement along the longitudinal column axis.
